(19) United States
(12) Patent Application Publication
(10) Pub. No.: US 2021/0386247 A1
(43) Pub. Date: Dec. 16, 2021

(54) Nut Cracker

(71) Applicant: Samir Moufawad Moufawad, Mazraat Yashouh (LB)

(72) Inventor: Samir Moufawad Moufawad, Mazraat Yashouh (LB)

(21) Appl. No.: 16/898,444

(22) Filed: Jun. 11, 2020

(51) Int. Cl. A47J 43/26

(52) U.S. Cl. CPC A47J 43/26

(57) ABSTRACT

The nut cracker of the present invention comprises two rotationally coupled handles pressed by hand or by the palm of the hand. Close to the rotation point and between the two handles, a curved or oblique jaw is coupled to one handle. Farther from the rotation point and between the two handles, a partial cup which accepts various nut sizes is coupled to the other handle. When the two handles are pressed, the jaw moves in the missing portion of the partial cup. The curved or oblique jaw and the partial cup confine the nut and prevent it from popping out, thus breaking the nut.

### BACKGROUND OF THE INVENTION

### Field of the Invention

Embodiments of the invention described herein pertain to the field of shell cracking. More particularly, but not by way of limitation, one or more embodiments of the invention enables a nut cracker with stronger breaking force.

### Description of the Related Art

Nut crackers are made to automatically fit different nut sizes, provide more crushing force by using a lever, or can do both automatic fitting of different nut sizes and providing more crushing force. While nut crackers with lever are somehow bulky with more parts, the ones without lever break the nut suddenly and more often cause the smashing of the nut. The present invention discloses a way to combine fitting of different nut sizes and more crushing force with a simple press of the hand or palm, and at the same time using two moving parts only.

### BRIEF SUMMARY OF THE INVENTION

The nut cracker of the present invention comprises two rotationally coupled handles pressed by hand or by the palm of the hand. Close to the rotation point and between the two handles, one handle is coupled to a curved or oblique jaw. The other handle is coupled farther from the rotation point to a partial cup which accepts various nut sizes. When the two handles are pressed, the jaw moves in the empty portion of the partial cup. The curved or oblique jaw and the partial cup confine the nut and prevent it from popping out, thus breaking the nut.

The advantage of this invention, besides adapting to various nut sizes, is that the crushing force is located near the rotation point thus producing greater force with small pressing force of the hand. And since the force is exerted on the side of the nut, the nut will be broken and not crushed.

### BRIEF DESCRIPTION OF THE DRAWINGS

The above and other aspects, features and advantages of the invention will be more apparent from the following more particular description thereof, presented in conjunction with the following drawings wherein:

FIG. 1 is a diagram of an exemplary two rotationally coupled handles with a partial cup and a curved jaw in accordance with the nut cracker described herein.

FIG. 2 is a diagram of an exemplary handles with a partial cup and an oblique jaw rotationally coupled at the bottom in accordance with the nut cracker described herein.

FIG. 3 is a diagram of an exemplary two rotationally coupled handles with a partial cup and a curved jaw accepting a walnut in accordance with the nut cracker described herein.

FIG. 4 illustrates an exemplary two rotationally coupled handles with a partial cup and a curved jaw breaking a walnut in accordance with the nut cracker described herein.

FIG. 5 is a diagram of an exemplary two rotationally coupled handles with a partial cup and a curved jaw accepting a hazelnut in accordance with the nut cracker described herein.

FIG. 6 illustrates an exemplary two rotationally coupled handles with a partial cup and a curved jaw breaking a hazelnut in accordance with the nut cracker described herein.

FIG. 7 is a diagram of an exemplary handles with a partial cup and a curved jaw rotationally coupled at the bottom accepting a walnut in accordance with the nut cracker described herein.

FIG. 8 is a diagram of an exemplary handles with a partial cup and a curved jaw rotationally coupled at the bottom breaking a walnut in accordance with the nut cracker described herein.

FIG. 9 is a diagram of an exemplary handles with a partial cup and a curved jaw rotationally coupled at the bottom accepting a hazelnut in accordance with the nut cracker described herein.

FIG. 10 is a diagram of an exemplary handles with a partial cup and a curved jaw rotationally coupled at the bottom breaking a hazelnut in accordance with the nut cracker described herein.

### DETAILED DESCRIPTION

The nut cracker will now be described using exemplary embodiments of the invention. It will be apparent to an ordinary skilled in the art person that the present invention may be practiced without incorporating all its aspects herein. Readers should note that although examples of the invention are set forth herein, the claims, and the full scope of any equivalents, are what define the metes and bounds of the inventions

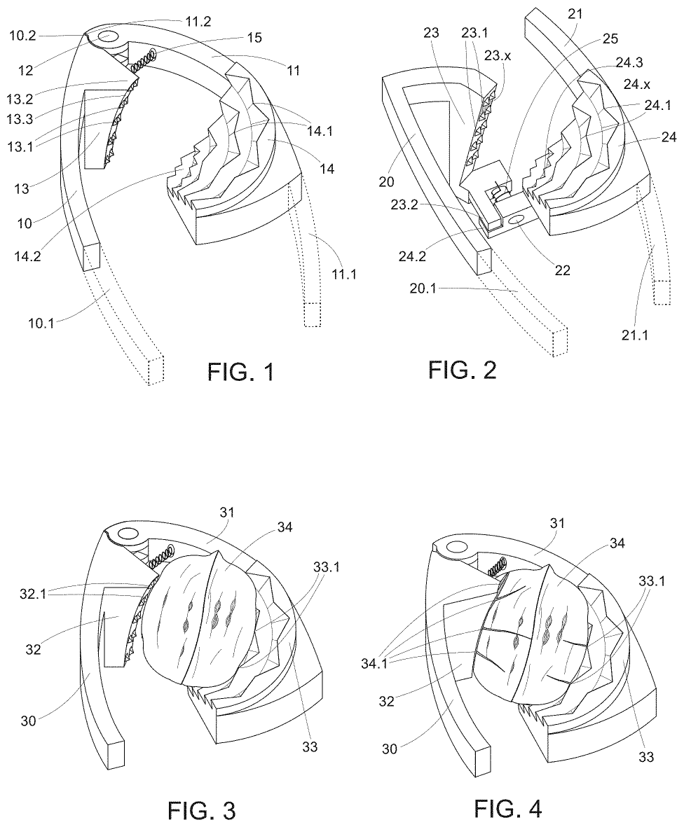

FIG. 1 is a diagram of an exemplary two rotationally coupled handles with a partial cup and a curved jaw in accordance with the nut cracker described herein.

Handle 10 is rotational coupled to handle 11 at pin 12. A curved jaw 13 is coupled near pin 12 to handle 10, and has preferably a rough surface or contains pins or teeth 13.1 for the purpose of better latching to and breaking a nut. Curved jaw 13 has its thicker part 13.2 at the top. A partial cup 14 is coupled farther from pin 12 on handle 11, and has preferably a rough surface or contains pins or teeth 14.1 for the purpose of better latching to and breaking a nut. Partial cup 14 is conical on the inside and has its narrower part 14.2 at the bottom.

Partial cup 14 has it missing portion oriented toward curved jaw 13. So, when handles 10 and 11 are pressed, curved jaw 13 moves in the missing portion of partial cup 14.

Edge 10.2 of handle 10 meets edge 11.2 of handle 11 to limit the opening of handles 10 and 11.

Handle 10 and 11 can be short to fit in the palm of the hand, or can be elongated 10.1 and 11.1 respectively, to provide more pressing force. Spring 15 pulls away handle 10 and 11 after being pressed and released.

FIG. 2 is a diagram of an exemplary handles with a partial cup and an oblique jaw rotationally coupled at the bottom in accordance with the nut cracker described herein.

Oblique jaw 23 is coupled to handle 20, and partial cup 24 is coupled to handle 21. Oblique jaw 23 and partial cup 24 are rotationally coupled at the bottom with pin 22. Oblique jaw 23 and partial cup 24 are preferably rough, or contain pins or teeth 23.1 and 24.1 respectively for the purpose of better latching to and breaking a nut. Oblique jaw 23 has its thicker part on top, while partial cup 24 is conical on the inside and has its narrower part 24.3 at the bottom.

Partial cup 24 has its missing portion oriented toward oblique jaw 23. So, when handles 20 and 21 are pressed, oblique jaw 23 moves in the missing portion of partial cup 24.

Handle 20 and 21 can be short to fit in the palm of the hand, or can be elongated 20.1 and 21.1 respectively, to provide more pressing force.

Stud 23.2 is coupled to the bottom of oblique jaw 23. When stud 23.2 touches lower part 24.2 of partial cup 24, it will limit the opening of handle 20 and 21. Spring 25 pulls away handle 20 and 21 after being pressed and released.

FIG. 3 is a diagram of an exemplary two rotationally coupled handles with a partial cup and a curved jaw accepting a walnut in accordance with the nut cracker described herein.

When a walnut 34 is placed on partial cup 33, it automatically falls to the lowest place between partial cup 33 and jaw 32. When the two handles 30 and 31 are pressed, teeth 32.1 and 33.1 latch to walnut 34 and since jaw 32 is curved, it will prevent walnut 34 from popping up.

FIG. 4 illustrates an exemplary two rotationally coupled handles with a partial cup and a curved jaw breaking a walnut in accordance with the nut cracker described herein.

When handles 30 and 31 are pressed toward each other, jaw 32 will break walnut 34 at 34.1 where jaw 32 or its teeth come in contact with walnut 34. Also, walnut 34 could be broken at teeth 33.1 the point of contact with partial cup 33.

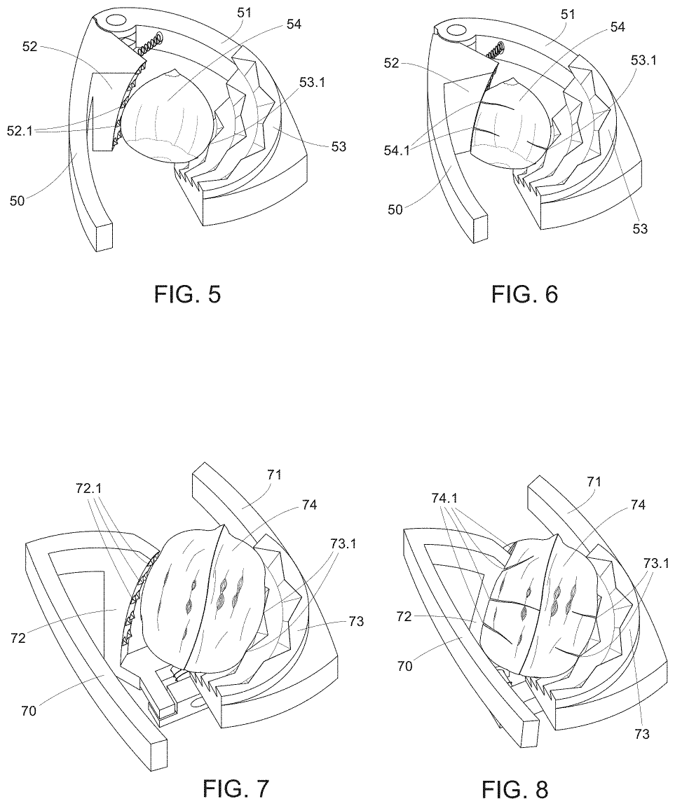

FIG. 5 is a diagram of an exemplary two rotationally coupled handles with a partial cup and a curved jaw accepting a hazelnut in accordance with the nut cracker described herein.

When hazelnut 54 is placed on partial cup 53, it automatically falls to the lowest place between partial cup 53 and jaw 52. When the two handles 50 and 51 are pressed, teeth 52.1 and tooth 53.1 latch to hazelnut 54 and since jaw 52 is curved, it will prevent walnut 54 from popping up. And as shown in FIG. 6, jaw 52 will break hazelnut 54 at 54.1. Also, hazelnut 54 could be broken at tooth 53.1.

FIG. 7 is a diagram of an exemplary handles with a partial cup and a curved jaw rotationally coupled at the bottom accepting a walnut in accordance with the nut cracker described herein.

When walnut 74 is placed on partial cup 73, it automatically falls to the lowest place between partial cup 73 and jaw 72. When the two handles 70 and 71 are pressed, teeth 72.1 and 73.1 latch to walnut 74 and since jaw 72 is curved, it will prevent walnut 74 from popping up. And as shown in FIG. 8, jaw 72 will break walnut 74 at 74.1. Also, walnut 74 could be broken at teeth 73.1.

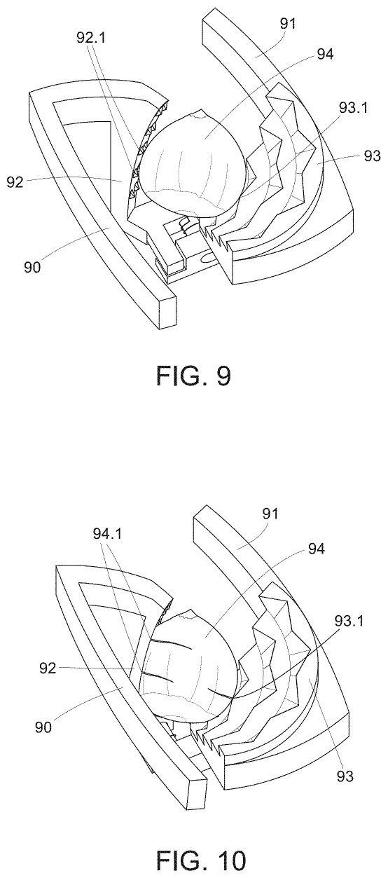

FIG. 9 is a diagram of an exemplary handles with a partial cup and a curved jaw rotationally coupled at the bottom accepting a hazelnut in accordance with the nut cracker described herein.

When hazelnut 94 is placed on partial cup 93, it automatically falls to the lowest place between partial cup 93 and jaw 92. When the two handles 90 and 91 are pressed, teeth 92.1 and tooth 93.1 latch to hazelnut 94 and since jaw 92 is curved, it will prevent walnut 94 from popping up. And as shown in FIG. 10, jaw 92 will break hazelnut 94 at 94.1. Also, hazelnut 94 could be broken at tooth 93.1.

1: A nut cracker including:
first handle with first end and second end;
second handle with end one and end two, wherein said first end is rotationally coupled to said end one;
a curved or oblique jaw with upper end and lower end, wherein said curved or oblique jaw is coupled to or an integral part of said first handle close to said first end, wherein said upper end is thicker relative to first handle than said lower end, and wherein said curved or oblique jaw has rough surfaces or contains at least one tooth; and
a partial cup with top end, bottom end and a missing portion, wherein said partial cup is coupled to or is an integral part of said second handle, wherein said partial cup is conical on the inside with said top end is wider relative to second handle than said bottom end, wherein said partial cup has rough surfaces or contains at least one tooth, wherein said missing portion has an open side toward said partial cup and closed side toward said end one, and wherein said curved or oblique jaw moves in said missing portion near said closed side.

2. (canceled)

3: The nut cracker of claim 1 further including a stop mechanism coupled to said first end and said end one.

4. (canceled)

5: The nut cracker of claim 1 further including a spring coupled to said first handle and said second handle.

6. (canceled)

7: The nut cracker of claim 3 further including a spring coupled to said first handle and said second handle.

8. (canceled)
